(19) United States
(12) Patent Application Publication
(10) Pub. No.: US 2006/0099371 A1
(43) Pub. Date: May 11, 2006

(54) Decorative laminate

(75) Inventor: Christopher White, Johnston, RI (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Gamer Graffix Worldwide, LLC, Cranston, RI (US)

(21) Appl. No.: 11/268,997

(22) Filed: Nov. 8, 2005

Related U.S. Application Data
(60) Provisional application No. 60/626,178, filed on Nov. 9, 2004.

(51) Int. Cl. B32B 33/00

(52) U.S. Cl. 428/40.1

(57) ABSTRACT

A decorative laminate includes an outer layer configured to provide decorative graphics, a structural layer configured to provide structural support to the laminate, and an adhesive layer configured to adhere to the substrate. The structural layer is disposed between the outer layer and the adhesive layer.

### RELATED APPLICATIONS

This application claims priority under 35 U.S.C. § 119(e) to U.S. Provisional Application Ser. No. 60/626,178, entitled “DECORATIVE LAMINATE RELEASABLY ATTACHABLE TO A SUBSTRATE,” filed on Nov. 9, 2004, which is herein incorporated by reference in its entirety.

### BACKGROUND OF THE INVENTION

1. Field of the Invention

The present invention relates generally to decorative stickers, and more particularly to a decorative laminate that is releasably attachable to a substrate, such as a personal gaming apparatus.

2. Discussion of Related Art

There are presently available in the entertainment gaming industry permanent stickers that are used to personalize an individual's gaming apparatus, such as those sold under the brand names GAME BOY® offered by Nintendo of America Inc., XBOX® offered by Microsoft Corporation, PLAYSTATION® offered by Sony Computer Entertainment Inc., and NINTENDO® offered by Nintendo of America Inc., to name a few. Such personalized stickers, which have decorative graphics imprinted thereon, are also used on related apparatus, such as personal computers, lap tops, personal music devices, controllers, accessories, and so forth.

One disadvantage associated with such prior art stickers is that they are not easily removable once they are applied. Oftentimes, it is desirable to remove stickers when exchanging the apparatus or otherwise trading in the apparatus. However, when removing the sticker, the strong adhesive typically used to apply the sticker to the apparatus can permanently mar or deface the apparatus since at least a portion of the sticker remains on the apparatus. Thus, the stickers, in some circumstances, can decrease the trade-in value of the apparatus due to the defaced surface caused by a sticker that is not completely removed. Also, it may be desirable, over time, to change the graphics on the apparatus.

### SUMMARY OF THE INVENTION

One aspect of the invention is directed to a decorative laminate that is releasably attachable to a substrate. In one embodiment, the decorative laminate comprises an outer layer constructed and arranged to provide structural support and decorative graphics, and an adhesive layer applied to the outer layer. The adhesive layer is constructed and arranged to adhere to the substrate.

Embodiments of the decorative laminate may include fabricating the outer layer with a flexible epoxy. The decorative laminate may further comprise a structural layer disposed between the outer layer and the adhesive layer. The structural layer comprises one of vinyl, thin sheet metal, or a decorative element. In other embodiments, the adhesive layer may comprise a water-based adhesive. The decorative laminate may further comprise a decorative element disposed within the outer layer, wherein the decorative element may include at least one fiber optic component constructed and arranged to transmit light or a heat sensitive material that reacts to change colors when exposed to variations in temperature. The decorative laminate may further comprise two mirrors disposed within the outer layer. One of the mirrors may be a one-way mirror to allow light to be trapped between the mirrors to create a three-dimensional effect.

Another aspect of the invention is directed to a decorative laminate comprising an outer layer constructed and arranged to provide decorative graphics, a structural layer constructed and arranged to provide structural support to the laminate, and an adhesive layer constructed and arranged to adhere to the substrate. The structural layer is disposed between the outer layer and the adhesive layer.

The present invention will be more fully understood after a review of the following drawing figures, detailed description and claims.

### DESCRIPTION OF THE DRAWINGS

For a better understanding of the present invention, reference is made to the drawing figures which are incorporated herein by reference and in which:

FIG. 1 is an exploded perspective view of a plurality of decorative laminates of one embodiment of the invention prior to being applied on an apparatus;

FIG. 2 is a perspective view of the decorative laminates viewed in FIG. 1 applied on the apparatus;

FIG. 3 is a perspective view of one of the decorative laminates viewed in FIG. 1;

FIG. 4 is an enlarged cross-sectional view taken along line 4--4 in FIG. 3;

FIG. 5 is an enlarged view of an end of the decorative laminate shown in FIG. 4;

FIG. 6 is an exploded view of the decorative laminate shown in FIG. 5;

FIG. 7 is a perspective view of a decorative laminate of another embodiment of the present invention;

FIG. 8 is a perspective view of the decorative laminate shown in FIG. 7 applied on an apparatus;

FIG. 9 is an exploded perspective view of the decorative laminate shown in FIG. 7;

FIG. 10 is top plan view of a decorative laminate of yet another embodiment of the present invention; and

FIG. 11 is an enlarged cross-sectional view taken along line 11-11 in FIG. 10.

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

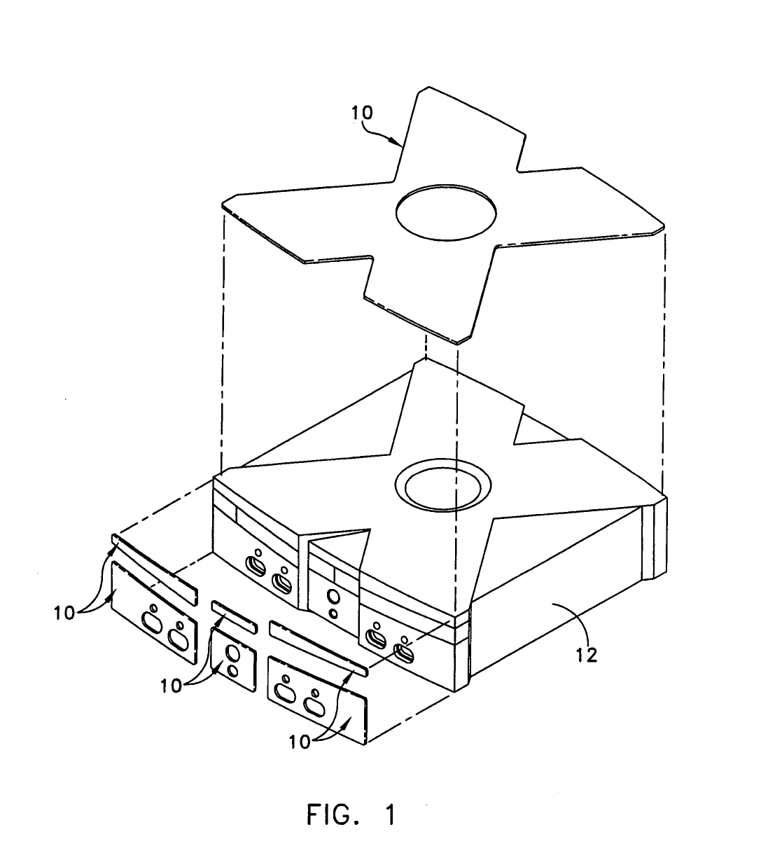

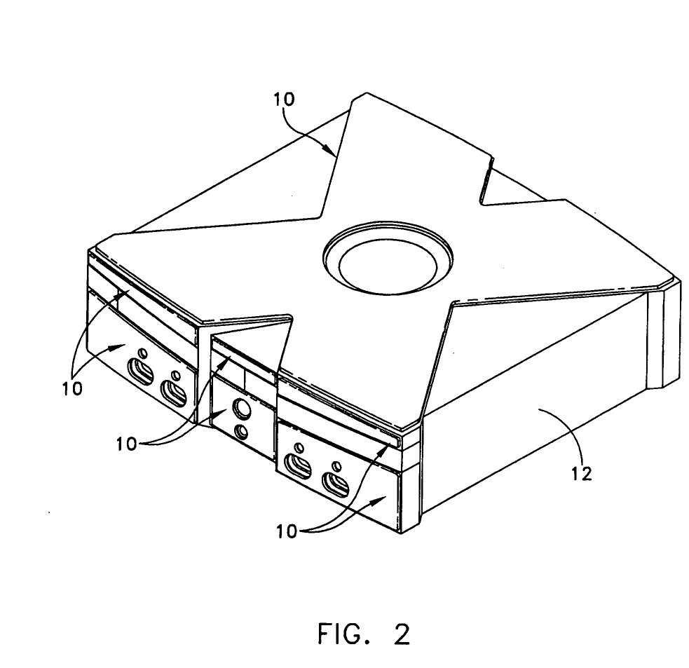

Referring now to the drawings, and more particularly to FIGS. 1 and 2, a plurality of decorative laminates of an embodiment of the present invention are each generally indicated at 10. Each decorative laminate 10 can be configured to be releasably applied to a substrate 12. In an embodiment of the invention, the substrate 12 can embody an individual gaming apparatus, such as GAME BOY, XBOX, PLAYSTATION, or NINTENDO gaming devices identified above. It should be understood that the decorative laminate 10 can be configured for application on any type of substrate including but not limited to personal computers, monitors, lap tops, personal music devices and related controllers and accessories. In addition, it is envisioned that the decorative laminate 10 of the present invention can embody graphics for automobiles and other vehicles. FIG. 1 illustrates the plurality of decorative laminates 10 prior to their application to the substrate 12. FIG. 2 illustrates the decorative laminates 10 applied to the substrate 12, e.g., an XBOX gaming device.

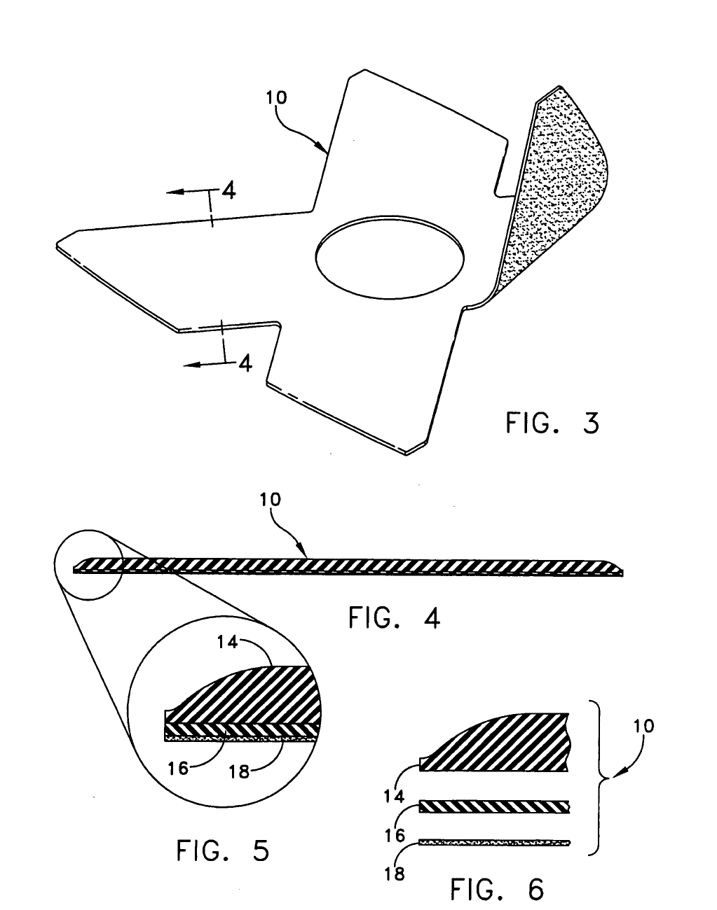

As shown in FIGS. 3-6, each decorative laminate 10 comprises three layers—an outer layer 14, a structural layer 16, and an adhesive layer 18. The structural layer 16 is disposed between the outer layer 14 and the adhesive layer 18, and is adapted to provide structural stability to the laminate 10. As will be described in greater detail below, the outer layer 14 can provide further structural support to additionally stabilize the laminate 10. The provision of a stabilized laminate 10 enables the decorative laminate to be applied and re-applied several times, while maintaining the clean look of the graphics depicted by the laminate.

In one embodiment, the outer layer 14 includes a flexible epoxy that can be manipulated to provide decorative graphics, e.g., by an air brush technique. In another embodiment, the flexible epoxy can be applied to a separate graphics layer. The outer layer 14 is the layer of the decorative laminate 10 that is viewed after applying the decorative laminate 10 to a substrate 18. In another embodiment, the outer layer 14 embodies a see-through layer that enables graphics provided on the structural layer 16 to show through the outer layer.

The structural layer 16, in at least one embodiment, comprises a vinyl material constructed and arranged to support the laminate 10. In this embodiment, the outer layer 14 may be applied to the structural layer 16. In another embodiment of the invention, the structural layer 16 comprises a thin sheet of metal, such as aluminum. In yet another embodiment, the structural layer 16 can provide a decorative element. For example, the structural layer 16 can embody a velvet sheet of material that is colored to resemble an object, such as a putting green used in golf. In addition, the structural layer and/or the adhesive layer can include sand to resemble a greenside bunker. With this particular arrangement, the velvet and sand can be used together to achieve a golfing motif, with the outer layer 14 providing the structural support for the laminate.

It should be understood that any number of materials can be used to form the structural layer to achieve a desired decorative motif and still fall within the scope of the present invention. For example, materials simulating snow, water, roads, trails, and the like may be used to constitute the structural layer and/or the outer layer.

In one embodiment, the adhesive layer 18 may include a glue comprising 10% ethylene, 10% 2Ht, 20% AB, 30% acrylic acidglacal, 10% peroxide, 10% acyl, and 10% water. It should be understood that any number of well known, water-based adhesives may be employed and fall within the scope of the present invention. The glue can be applied to the structural layer 16 using any number of coating or laminating techniques, such as a spraying process. Once assembled, the decorative laminate 10 can be manipulated, e.g., by a stamping process, to achieve a desired configuration. Reference can be made to the attached drawing figures that illustrate sample designs. The decorative laminate 10 may be manipulated by any number of processes to achieve a certain look or design.

The adhesive layer 18 allows the releasable attachment of the decorative laminate 10 to the substrate 12, without risk of permanently marring or defacing the substrate when removing the laminate from the substrate but has sufficient adhesive properties to remain adhered to the substrate 12. Specifically, the adhesive is of the type that does not permanently adhere to the substrate. In addition, since the vinyl substrate layer 16 retains its integrity during use, the structural layer peels away from the substrate, even if some of the adhesive layer remains on the substrate. Adhesive residue left on the substrate can be easily cleaned off the substrate with an appropriate cleaner.

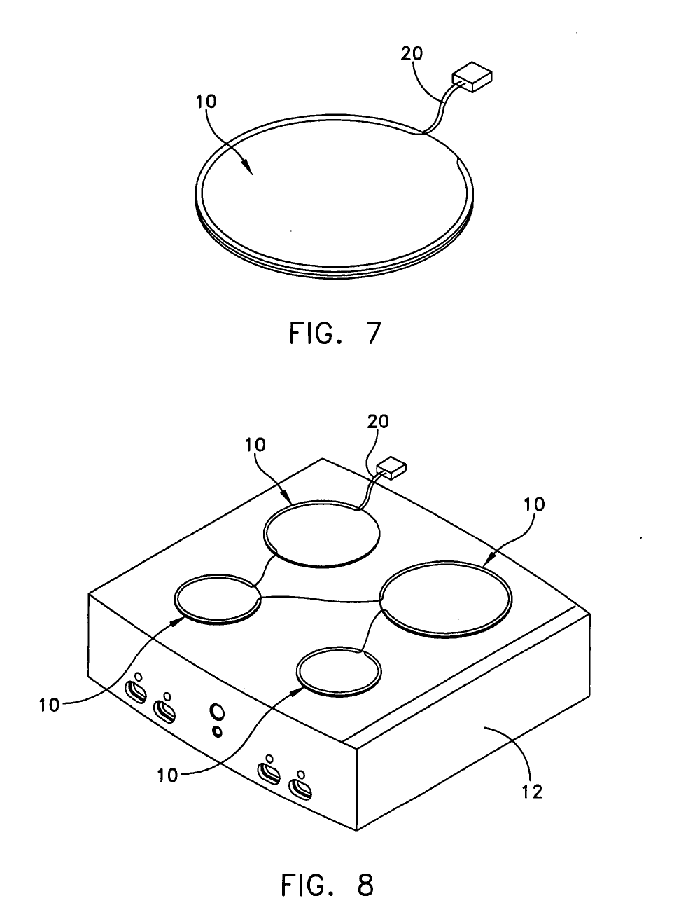

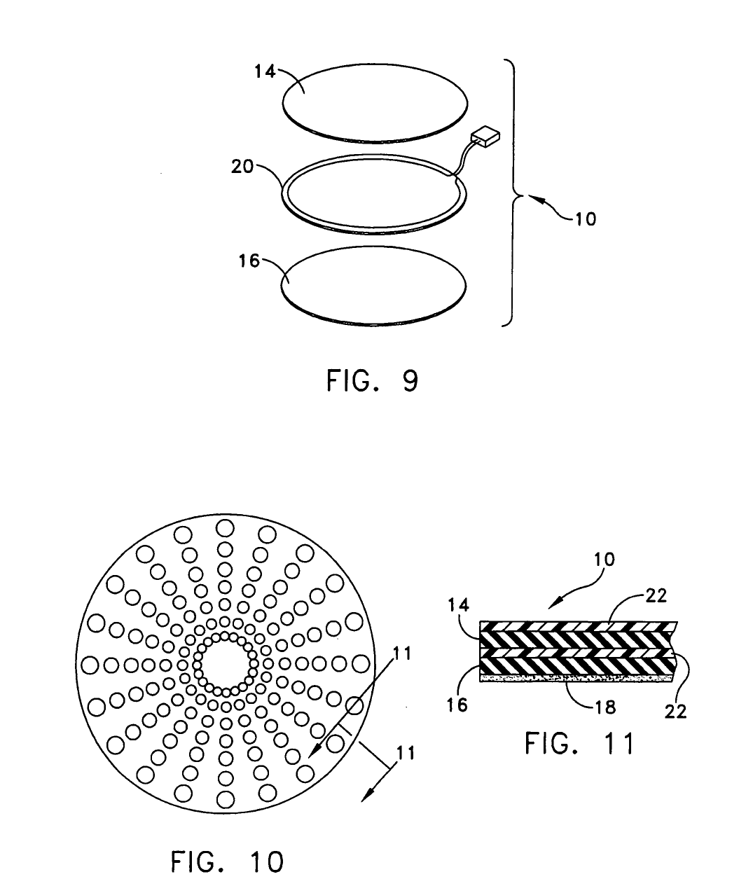

Referring to FIGS. 7-9, and more particularly to FIG. 9, a decorative element 20 is disposed between the outer layer 14 and the structural layer 16. In one embodiment of the invention, the decorative element 20 embodies a fiber optic component adapted to transmit light to illuminate the decorative laminate 10. The fiber optic component can be adapted to transmit light having different colors from a suitable light source. Thus, the decorative element 20, along with the graphics contained within the outer layer 12, enables light to be reflected on the graphics to provide an added design effect. Although FIGS. 7-9 illustrate the fiber optic component positioned near the periphery of the decorative laminate, it is contemplated that it can extend anywhere within the decorative laminate.

In another embodiment of the invention, the decorative element may include a heat sensitive material that reacts to variations of environmental conditions (e.g., changes in temperature) to change colors. The decorative element may be selectively positioned between the outer layer 14 and the structural layer 16. A representative material embodying the decorative element may be cobalt or an alloy of cobalt. Thus, the decorative element changes the color of the decorative laminate 10 when a person touches or places a body part near the outer layer 14 of the decorative laminate, for example. This feature may provide a fun, interactive design element.

Turning now to FIGS. 10 and 11, two one-way mirrors, each indicated at 22, may be selectively positioned between the outer layer 14 and the structural layer 16 to create a three-dimensional effect. Specifically, one mirror 22 may be positioned adjacent the outer surface of the outer layer 14 to allow light within the laminate 10 while reflecting light trapped within the laminate. A second mirror is positioned adjacent the structural layer 16 to reflect light allowed into the laminate 10 by the outermost mirror. It should be noted that the second mirror 22 does not have to be a two-way mirror since it is not required to allow light within the laminate. As shown in FIG. 10, the mirrors 22 create the illusion of depth within the decorative laminate 10 since light trapped in the space between the mirrors reflect back and forth between the mirrors to create a three-dimensional effect.

It should be understood that the decorative laminate 10 of the present invention can be releasably applied to substrates other than gaming apparatus, such as in the automobile industry.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A decorative laminate releasably attachable to a substrate, the decorative laminate comprising:
an outer layer constructed and arranged to provide structural support and decorative graphics; and
an adhesive layer applied to the outer layer, the adhesive layer being constructed and arranged to adhere to the substrate.

2. The decorative laminate of claim 1, wherein the outer layer comprises a flexible epoxy.

3. The decorative laminate of claim 1, the outer layer comprising a structural layer, disposed between the outer layer and the adhesive layer, the structural layer comprising one of vinyl, thin sheet metal, or a decorative element.

4. The decorative laminate of claim 1, wherein the adhesive layer comprises a water-based adhesive.

5. The decorative laminate of claim 1, further comprising a decorative element disposed within the outer layer.

6. The decorative laminate of claim 5, wherein the decorative element comprises at least one fiber optic component constructed and arranged to transmit light.

7. The decorative laminate of claim 5, wherein the decorative element comprises a heat sensitive material that reacts to change colors when exposed to variations in temperature.

8. The decorative laminate of claim 1, further comprising two mirrors disposed within the outer layer, one of the mirrors being a one-way mirror to allow light to be trapped between the mirrors to create a three-dimensional effect.

9. A decorative laminate releasably attachable to a substrate, the decorative laminate comprising:
an outer layer constructed and arranged to provide decorative graphics;
a structural layer constructed and arranged to provide structural support to the laminate; and
an adhesive layer constructed and arranged to adhere to the substrate,
wherein the structural layer is disposed between the outer layer and the adhesive layer.

10. The decorative laminate of claim 9, wherein the outer layer comprises a flexible epoxy.

11. The decorative laminate of claim 9, wherein the structural layer comprises one of vinyl, thin sheet metal, or a decorative element.

12. The decorative laminate of claim 9, wherein the adhesive layer comprises a water-based adhesive.

13. The decorative laminate of claim 9, further comprising a decorative element disposed between the outer layer and the structural layer.

14. The decorative laminate of claim 13, wherein the decorative element comprises at least one fiber optic component constructed and arranged to transmit light.

15. The decorative laminate of claim 13, wherein the decorative element comprises a heat sensitive material that reacts to change colors when exposed to variations in temperature.

16. The decorative laminate of claim 9, further comprising two mirrors disposed within the outer layer, one of the mirrors being a one-way mirror to allow light to be trapped between the mirrors to create a three-dimensional effect.
